(19) United States
(12) Patent Application Publication
(10) Pub. No.: US 2005/0036473 A1
(43) Pub. Date: Feb. 17, 2005

(54) Method and apparatus for transmitting a beacon and communicating a frame

(75) Inventors: Kab-Joo Lee, Sungnam-si (KR); Jae-Sun Choi, Bucheon-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO. , LTD.

(21) Appl. No.: 10/916,757

(22) Filed: Aug. 12, 2004

(30) Foreign Application Priority Data
Aug. 13, 2003 (KR) 2003-56129

(51) Int. Cl. H04J 3/00; G08C 17/00

(52) U.S. Cl. 370/345

(57) ABSTRACT

A beacon having a traffic indication map (TIM) and information concerning a beacon interval is generated. The generated beacon is transmitted to stations prior to lapse of Point Coordination Function Interframe Space (PCF IFS) after detecting the condition of the channel. The beacon is transmitted prior to the lapse of PIFS from the time of detecting the condition of the channel to the stations. Therefore, the beacon is transmitted to the stations prior to a frame having a data is transmitted to the stations.

### CROSS-REFERENCE TO RELATED APPLICATIONS

This application claims priority from the Korean Patent Application No. 2003-56129, filed on Aug. 13, 2003, the contents of which are incorporated herein by reference in its entirety.

### BACKGROUND

1. Technical Field

The present invention relates to a method and an apparatus for transmitting a beacon and communicating a frame. More particularly, the present invention relates to a method and an apparatus for transmitting a beacon and a method and an apparatus for communicating, i.e., transmitting and/or receiving, a frame capable of reducing consumption of power.

2. Discussion of the Related Art

In conventional wireless Local Area Network (LAN) systems, a wireless access point generates a beacon having information on a Traffic Indication Map (TIM) and a beacon interval, and transmits the generated beacon to a plurality of stations. The access point can be an apparatus for transmitting the beacon or an apparatus for communicating, i.e., transmitting and/or receiving, a frame. The station can be the apparatus for transmitting/receiving the frame.

The wireless LAN system adopts Carrier Sense Multiple Access with Collision Avoidance (CSMA/CA) Access Mode. The CSMA/CA access mode corresponds to a contention mode. Therefore, the priority of transmitting the beacon is substantially lower than that of transmitting the frame. As a result, the beacon may be typically transmitted later than the frame in the CSMA/CA access mode. Hence, the station operating in a power saving mode may keep operating for a long time. Consequently, the power consumption in the station, which is in the power saving mode, is a waste. Therefore, there is a need for an apparatus for transmitting the beacon and an apparatus for transmitting/receiving the frame that are capable of reducing the power consumption.

### SUMMARY OF THE INVENTION

A method of transmitting a beacon and an apparatus for performing the same, which is also capable of transmitting the beacon prior to the transmission of a frame having a data, is provided.

A method of transmitting/receiving a frame using a beacon transmission and an apparatus for performing the same, which is also capable of reducing the power consumption, is provided.

A method of transmitting a beacon, which detects the condition of a channel, is provided. Also, the beacon having information about a Traffic Indication Map (TIM) and a beacon interval is generated. Further, the generated beacon is transmitted to the stations prior to the lapse of Point Coordination Function (PCF) InterFrame Space (IFS) after the detection of the condition of the channel. The beacon transmission is performed when the channel is empty. The TIM has information about the data to be transmitted.

Method of transmitting/receiving a frame using a beacon transmission is disclosed, the method uses a technique for detecting the condition of a channel. The beacon having information concerning TIM and a beacon interval is generated. A short IFS (SIFS), a PCF IFS (PIFS) and a Distributed (coordination function) InterFrame Space (referred hereinafter to as “DIFS” or “DCF IFS”) from detection time of the condition of the channel are detected.

The generated beacon is transmitted to the stations prior to lapse of PIFS after detecting the condition of the channel. A frame having data may be transmitted or received after lapse of the DIFS from the time the channel condition is detected. Further, an acknowledgement (referred hereinafter to as “ACK”) frame may be transmitted after lapse of the SIFS from the time the channel condition is detected. Upon transmission and reception of the frame, a first frame with a first data may be transmitted and a second frame with a second data may be received. The beacon is transmitted when the channel is empty. The TIM has information about the data to be transmitted.

An apparatus for transmitting a beacon according to at least one exemplary embodiment of the invention includes a channel condition detecting section and a beacon section. A section is a module or part of the apparatus for transmitting beacon or the apparatus for communicating a frame. The channel condition detecting section detects the condition of a channel. The beacon section generates the beacon including information concerning TIM and a beacon interval, and provides the generated beacon prior to the lapse of a PIFS after detecting the channel condition.

An apparatus for transmitting/receiving a frame using a beacon transmission according to at least one exemplary embodiment of the present invention includes a channel condition detecting section, a beacon section, a timing section and a frame section. The channel condition detecting section detects the condition of a channel. The beacon section generates the beacon including the information concerning TIM and a beacon interval, and provides the generated beacon prior to lapse of a PIFS after detecting the channel condition.

The timing section detects time elapsed from the time of detecting the channel condition. The frame section transmits/receives the frame having data in accordance with the elapsed time. Further, the timing section may include a first timer for detecting the SIFS, a second timer for detecting the PIFS, a third timer for detecting the DIFS, and a fourth timer for detecting a backoff time. The beacon section may include a beacon generating section for generating the beacon with information on the TIM and the beacon interval, and a beacon transmitting section for transmitting the generated beacon.

The frame section may include a frame transmitting section for transmitting a first frame with a first data, a frame receiving section for receiving a second frame with a second data, and a response signal generating section for providing a response frame. In addition, the response frame may be an ACK frame. The frame section provides the frame after the DIFS from time of detecting the channel condition.

As described above, a method and apparatus for transmitting the beacon provides the beacon prior to lapse of the PIFS from the time the condition of the channel is detected. Therefore, the beacon can be preferably transmitted to the stations earlier than the frame having the data is transmitted thereto.

In addition, the method of transmitting/receiving the frame and the apparatus for performing the same preferably transmits the beacon earlier than the frame having the data to the stations. Thus, the consumption of power may be reduced.

### BRIEF DESCRIPTION OF THE DRAWINGS

Preferred embodiments of the invention are described with reference to the accompanying drawings, of which:

FIG. 1 is a schematic view illustrating a basic wireless LAN system;

FIG. 2 shows an apparatus for transmitting/receiving a frame using a beacon transmission according to an embodiment of the present invention;

FIG. 3 is a block diagram illustrating a timing section according to an embodiment of the present invention;

FIG. 4A is a block diagram illustrating a beacon section according to an embodiment of the present invention;

FIG. 4B is a schematic view illustrating the beacon according to an embodiment of the present invention;

FIG. 5 is a block diagram illustrating a frame section according to an embodiment of the present invention;

FIG. 6 is a schematic timing diagram illustrating operation of transmitting the beacon and the frame in power save mode according to an embodiment of the present invention;

FIG. 7 is a flowchart illustrating process of transmitting the beacon according to an embodiment of the present invention; and

FIG. 8 is a flowchart illustrating process of transmitting/receiving the frame according to an embodiment of the present invention.

### DETAILED DESCRIPTION OF THE INVENTION

The preferred embodiments of the present invention will be described with reference to the appended drawings.

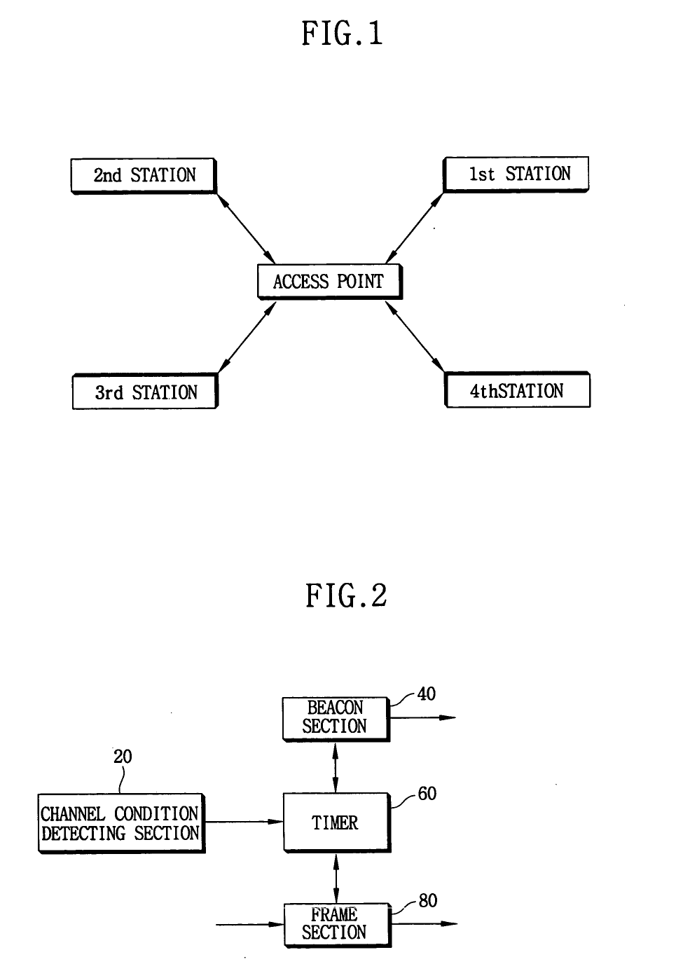

FIG. 1 is a schematic view illustrating a basic wireless LAN system. Referring to FIG. 1, the wireless LAN system includes an access point and a plurality of stations. The wireless LAN system operates pursuant to the IEEE 802.11 standard. The access point wirelessly connects terminals of the stations to a wired LAN. The access point transmits a first frame having a first data to the stations, and receives a second frame having a second data from the stations. For example, the access point receives an exemplary frame from a first station, and transmits the received frame to a second station. In other words, the stations do not directly exchange the frame with each other. However, the stations exchange the frame with each other through the access point. The apparatus for transmitting/receiving the frame of the present invention can be the access point or the station.

Under the Wireless LAN standard of IEEE 802.11, a medium access control (MAC) employs either a contention mode or contention-free mode. Also, the contention mode is designated as Carrier Sense Multiple Access with Collision Avoidance (CSMA/CA) or Distribution Coordination Function (DCF). Whereas, the contention-free mode is designated as point coordination function (PCF). Hereinafter, the contention mode is referred to as the DCF, and the contention-free mode is referred to as the PCF. The wireless LAN system employs the contention-free access method to transmit/receive the frame.

FIG. 2 shows an apparatus for transmitting/receiving a frame using a beacon transmission according to an embodiment of the present invention.

Referring to FIG. 2, the illustrative apparatus for transmitting/receiving the frame may include a channel condition detecting section 20, a beacon section 40, a timing section 60 and a frame section 80. The apparatus for transmitting/receiving the frame can be the access point in the wireless LAN.

The channel condition detecting section 20 detects the conditions of a channel, including whether or not the frame is transmitted through the channel. The channel can use a frequency bandwidth of 2.4 GHz. The beacon section 40 generates a beacon having information concerning a traffic indication map (hereinafter, referred to as “TIM”) and a beacon interval. In addition, the beacon section 40 provides the beacon at every beacon interval.

The apparatus for transmitting the beacon and the apparatus for transmitting/receiving the frame may be operated in a power saving mode to reduce the overall power consumption by the apparatus. Each of the stations is not always “awake”, i.e., operational, but becomes awake at predetermined periods. Such predetermined period may be integral times as large as the beacon interval. The stations may differ individually with respect to the awake period with each other. In other words, each of the stations sets itself period using the received beacon.

In the case where each of the stations operates in the power saving mode and, hence is not always awake; each of the stations may save significantly power in comparison to the stations that are always awake. In the power saving mode, the stations keep awake until they receive the beacon after they are woken-up. Therefore, the time spent from awake time until receiving the beacon is reduced, and hence more power is saved for the stations in power saving mode.

The TIM includes data transmission information. For example, when the apparatus for transmitting/receiving the frame has data to be transmitted to the first station, the apparatus for transmitting/receiving the frame transmits the data transmission information to the first station using the beacon. And when the first station receives the data transmission information, the first station transmits a transmission request frame (hereinafter, referred to as the “PS-Poll frame”) to the apparatus for transmitting/receiving the frame, such as the access point. Further, when the apparatus for transmitting/receiving the frame receives the PS-Poll frame, the apparatus for transmitting/receiving the frame transmits a frame having the data to the first station.

The conventional apparatus for transmitting the beacon and apparatus for transmitting/receiving the frame provide the beacon through contention with the frame having the data to the station. Hence, the beacon may be provided later to the station than the frame. However, the apparatus for transmitting the beacon and apparatus for transmitting/receiving the frame in at least one embodiment of the present invention always transmit the beacon prior to transmission of the frame to the station. Therefore, awake time of the station required for providing the beacon is reduced. As a result, the power consumption of the stations in the power save mode is reduced.

A timing section 60 detects short InterFrame Space (short IFS), PCF IFS (PIFS), DCF IFS (DIFS) and backoff time. A frame section 80 transmits/receives the frame having the data.

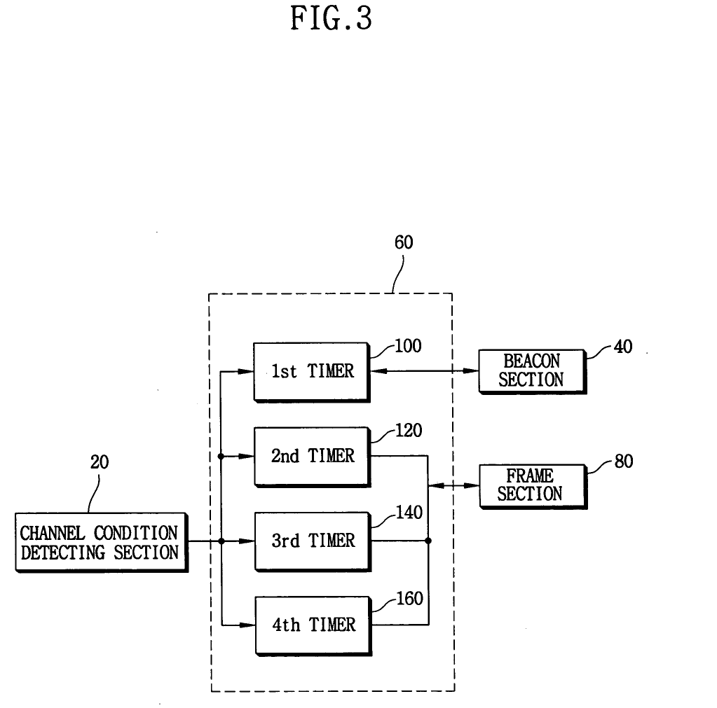

Referring to FIG. 3, the timing section 60 includes a first timer 100, a second timer 120, a third timer 140 and a fourth timer 160. The first timer 100 detects lapse time of the SIFS after detecting the condition of the channel. The second timer 120 detects lapse time of the PIFS after detecting the condition of the channel. The third timer 140 detects lapse time of the DIFS after detecting the condition of the channel. The fourth timer 160 detects the backoff time.

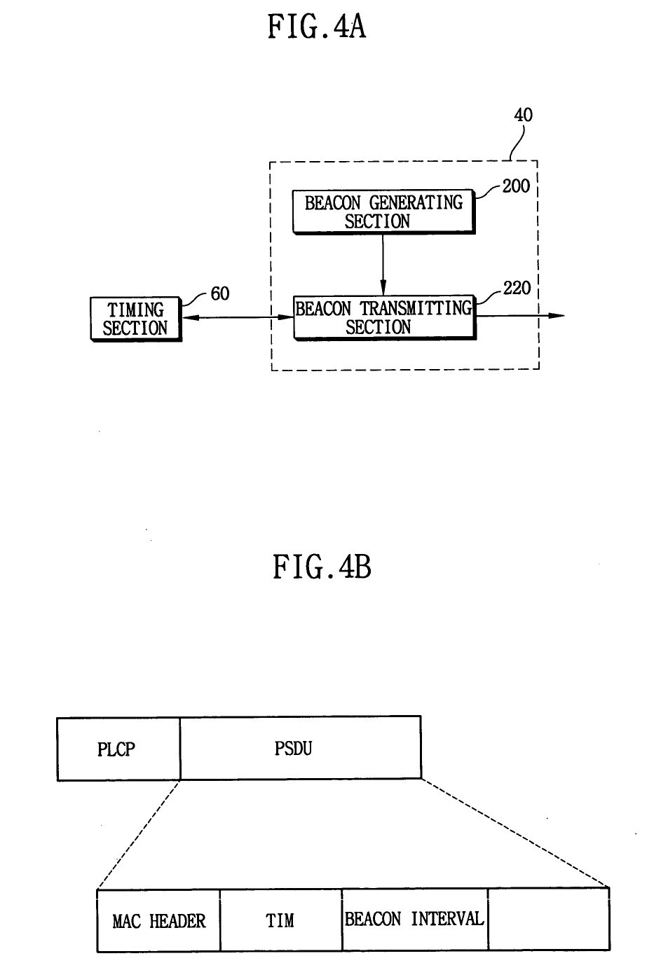

Referring to FIG. 4A, the beacon section 40 includes a beacon generating section 200 and a beacon transmitting section 220. The beacon generating section 200 generates the beacon having information concerning the TIM and the beacon interval. The beacon transmitting section 220 transmits the generated beacon to the stations.

As shown in FIG. 4B, the beacon includes the information concerning the TIM and the beacon interval.

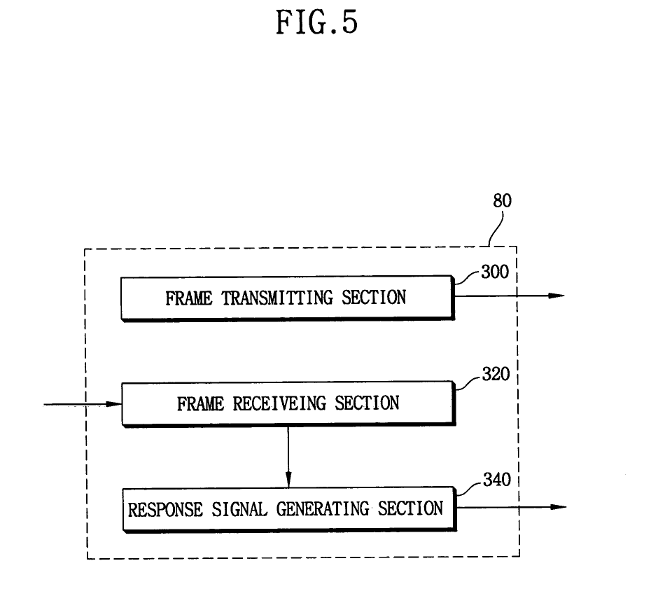

Referring to FIG. 5, the frame section 80 includes a frame transmitting section 300, a frame receiving section 320 and a response signal generating section 340. The frame transmitting section 300 transmits the first frame having the first data to the stations. The frame receiving section 320 receives the second frame having the second data from the stations. The first frame may be substantially identical to the second frame. The response signal generating section 340 transmits a response frame such as an acknowledgment frame (ACK frame) to the stations.

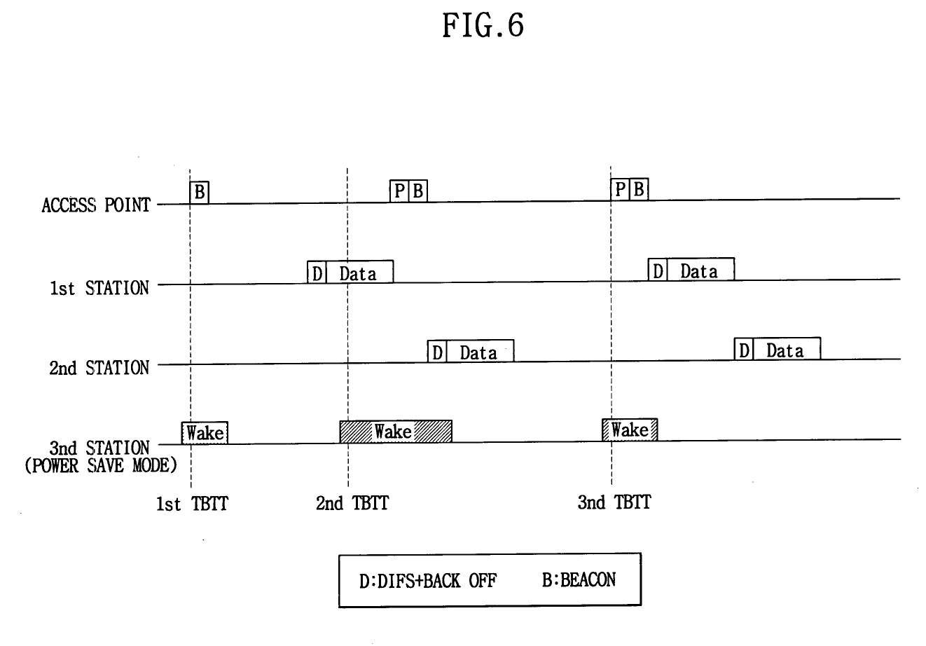

Shown in FIG. 6 is the apparatus for transmitting the beacon and the apparatus for transmitting/receiving the frame generate the beacon including the information concerning the TIM and the beacon interval. The generated beacon is transmitted in accordance with the beacon interval.

The apparatus for transmitting the beacon and the apparatus for transmitting/receiving the frame (for example, the access point) start transmission of the beacon at Target Beacon Transmission Time (hereinafter, referred to as “TBTT”). The frame from the first station is transmitted to the access point at a second TBTT. Therefore, the generated beacon cannot be transmitted to the stations. After the frame of the first station has been transmitted to the access point, the access point transmits the generated beacon prior to lapse of the PIFS to the stations. (The P in FIG. 6 denotes PIFS) The frame having data is transmitted to the access point after the lapse of the DIFS. In other words, the beacon is transmitted prior to transmission of the frame. Hence, the beacon has greater transmission priority than the frame.

Since a third station has been waked-up just prior to the second TBTT, and then it keeps waking-up until the beacon is received. In the conventional apparatus for transmitting the beacon and apparatus for transmitting/receiving the frame, the beacon may have substantially lower transmission priority than the frame. As a result, when the third station defers due to contention with the second station, the third station in the power save mode must keep waking-up for a long time until the beacon is received.

As described above, the third station of the present invention keeps less awake than the third station of the conventional apparatus. Hence, the third station of the invention may save the power in comparison to the third station of the conventional apparatus.

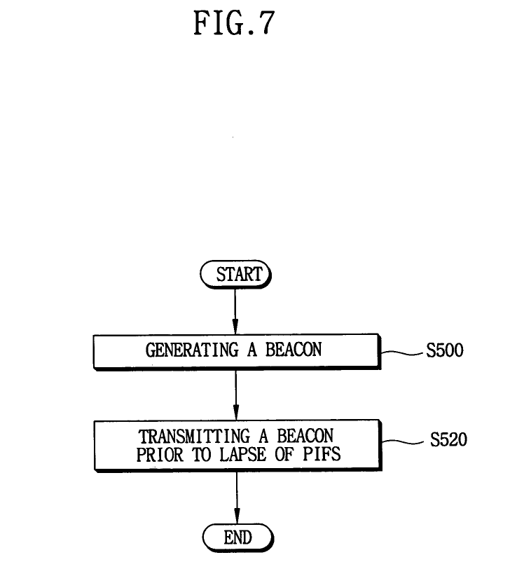

Referring to FIG. 7, in step S500, the beacon generating section 200 generates the beacon with information on the TIM and the beacon interval. In step S520, the generated beacon is transmitted to the stations prior to lapse of the PIFS.

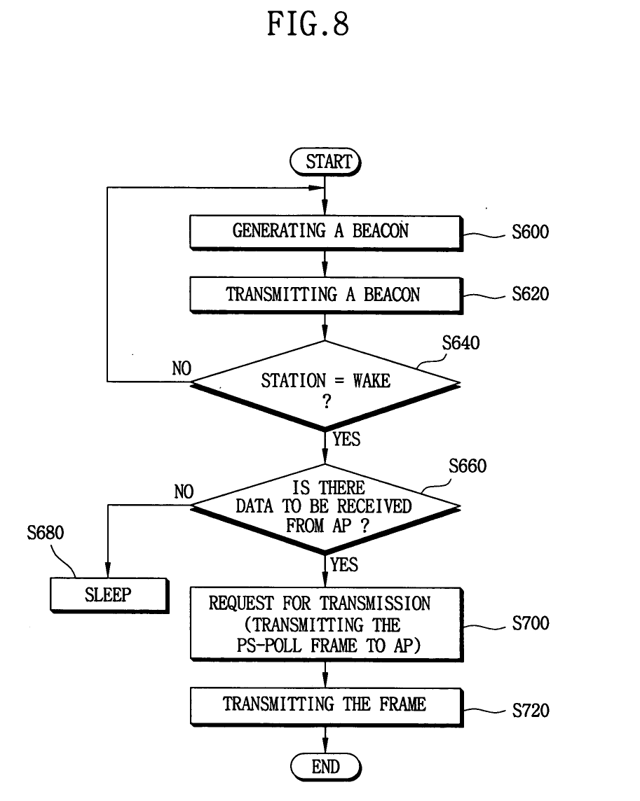

Referring to FIG. 8, in step S600, the beacon generating section 200 generates the beacon with information on the TIM and the beacon interval. And the generated beacon is transmitted to the stations in step S620. In step S640, It is determined whether or not the station in the power saving mode is awake. When the station in the power saving mode is not awake, the step 600 is performed again. In step S660, when the station in the power saving mode is awake, the station determines from the received beacon whether or not the access point has the data to be transmitted thereto. In step S680, when the access point does not have the data, the station is converted into in a sleep state. In step S700, when the access point has the data to be transmitted to the station, the station transmits the PS-Poll frame to the access point. And then, in step S720, when the access point receives the PS-Poll frame, the access point transmits the frame having the data to the station.

While the present invention has been particularly shown and described with reference to exemplary embodiments thereof, it will be understood by those skilled in the art that various changes in form and details may be made therein without departing from the spirit and scope of the present invention as defined by the appended claims.

1. A method of transmitting a beacon, the method comprising:
detecting the condition of a channel;
generating a beacon having information concerning a Traffic Indication Map (TIM) and a beacon interval; and
transmitting the generated beacon to a station prior to the lapse of PIFS (Point Coordination Function Interframe Space) after detecting the condition of the channel.

2. The method of claim 1, wherein the step of transmitting the generated beacon to the station is performed when the channel is empty.

3. The method of claim 1, wherein the Traffic Indication Map includes information concerning data to be transmitted to the station.

4. A method of transmitting/receiving a frame using transmission of a beacon, the method comprising:
detecting the condition of a channel;
generating a beacon having information concerning a Traffic Indication Map (TIM) and a beacon interval;
detecting a SIFS (short Interframe Space), a PIFS (Point Coordination Function Interframe Space) and a DIFS (Distributed Coordination Function Interframe Space) from the time of detecting the condition of the channel;
transmitting the generated beacon to a station prior to the lapse of the PIFS after detecting the condition of the channel; and
communicating a frame having data after the DIFS from the time of detecting the condition of the channel.

5. The method of claim 4, further comprising:
transmitting an Acknowledgement (ACK) frame after the SIFS from the time of detecting the condition of the channel.

6. The method of claim 4, wherein the step of communicating the frame after the DIFS comprising:
transmitting a first frame having a first data; and
receiving a second frame having a second data.

7. The method of claim 4, wherein the beacon is transmitted to the station when the channel is empty.

8. The method of claim 4, wherein the Traffic Indication Map includes information concerning the data to be transmitted.

9. An apparatus for transmitting a beacon, the apparatus comprising:
a channel condition detecting section for detecting the condition of a channel; and
a beacon section for generating the beacon and transmitting the generated beacon prior to the lapse of a PIFS (Point Coordination Function Interframe Space) after detecting the condition of the channel, wherein the beacon includes information corresponding to a traffic indication map (TIM) and a beacon interval.

10. The apparatus of claim 9, wherein the beacon is transmitted when the channel is empty.

11. The apparatus of claim 9, wherein the Traffic Indication Map includes a data transmission information unit, the data transmission information unit corresponding to the data to be transmitted.

12. The apparatus for communicating a frame using transmission of a beacon, the apparatus comprising:
a channel condition detecting section for detecting the condition of a channel;
a beacon section for generating the beacon and providing the generated beacon prior to lapse of a PIFS (PCF IFS) after detection of the condition of the channel, the beacon including information concerning a traffic indication map (TIM) and a beacon interval;
a timing section for detecting a time elapsed from the time of detecting the condition of the channel; and
a frame section for communicating the frame having data in accordance with the time elapsed.

13. The apparatus of claim 12, wherein the timing section includes
a first timer for detecting a short Interframe Space (SIFS);
a second timer for detecting a Point Coordination Function Interframe Space (PIFS);
a third timer for detecting a Distributed Coordination Function Interframe Space (DIFS); and
a fourth timer for detecting a backoff time.

14. The apparatus of claim 12, wherein the beacon section includes
a beacon generating section for generating the beacon having the information concerning the traffic indication map and the beacon interval; and
a beacon transmitting section for transmitting the generated beacon to at least one station that receives and transmits frames of data.

15. The apparatus of claim 12, wherein the frame section includes
a frame transmitting section for transmitting a first frame having a first data to at least one station that receives and transmits frames of data;
a frame receiving section for receiving a second frame having a second data from at least one station that receives and transmits frames of data; and
a response signal generating section for providing a response frame.

16. The apparatus of claim 15, wherein the response frame corresponds to an Acknowledgement (ACK) frame.

17. The apparatus of claim 12, wherein the beacon section transmits the beacon to stations when the channel is empty.

18. The apparatus of claim 12, wherein the beacon section transmits the beacon prior to lapse of a Point Coordination Function Interframe Space (PCF IFS) after detecting the condition of the channel to the stations.

19. The apparatus of claim 12, wherein the frame section provides the frame after Distributed Coordination Function Interframe Space (DIFS) from the time of detecting the condition of the channel.

20. The apparatus of claim 12, wherein the Traffic indication Map includes a data transmission information unit having an information unit corresponding to the data to be transmitted to at least one station for receiving and transmitting frames of data.

21. A method of transmitting/receiving a frame in a wireless network,
the method comprising:
transmitting a beacon to a station with a transmission priority higher than the transmission priority of a frame; and
communicating the frame having at least one datum to the station with a transmission priority lower than the transmission priority of the beacon.

22. The method of claim 21 further comprising:
detecting the condition of a channel;
generating the beacon having information concerning a Traffic Indication Map (TIM) and a beacon interval; and
transmitting the generated beacon to a station prior to the lapse of PIFS (Point Coordination Function Interframe Space) after detecting the condition of the channel, wherein the station transmitting and receiving the frame having at least one datum.

23. The method of claim 22, wherein the step of transmitting the generated beacon to the station is performed when the channel is empty.

24. The method of claim 22, wherein the Traffic Indication Map includes at least one information unit concerning at least one datum to be transmitted to the station.
